(19) United States
(12) Patent Application Publication
(10) Pub. No.: US 2004/0145537 A1
(43) Pub. Date: Jul. 29, 2004

(54) Apparatus for displaying a three-dimensional image and process of making the same

(75) Inventors: Atsushi Yoshizawa, Tsurugashima-shi (JP); Takashi Chuman, Tsurugashima-shi (JP); Yoshihiko Uchida, Tsurugashima-shi (JP); Hideo Satoh, Tsurugashima-shi (JP); Takuya Hata, Tsurugashima-shi (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/758,531

(22) Filed: Jan. 16, 2004

(30) Foreign Application Priority Data
Jan. 24, 2003 (JP) 2003-15933

(51) Int. Cl. G09G 5/00

(52) U.S. Cl. 345/6

(57) ABSTRACT

A three-dimensional image displaying device includes a front display unit and a rear display unit. The front display unit includes at least one transparent display screen. The display screen includes a plurality of organic electroluminescent elements. A spacer is provided between the front and rear display units.

### BACKGROUND OF THE INVENTION

1. Field of the Invention

The present invention relates to an apparatus for displaying a three-dimensional image, and a method of fabricating such display apparatus.

2. Description of the Related Art

Various types of apparatus for displaying a three-dimensional image are known in the art. For example, Japanese Patent Kokai No. 2000-115812 discloses one type of a three-dimensional image displaying apparatus. FIG. 1 of the accompanying drawings schematically illustrates this apparatus. The three-dimensional displaying apparatus 1 uses two planar images. These two two-dimensional images are identical, but have different brightness, and are superposed when viewed from a viewer.

The display apparatus 1 includes a front display unit 2 and a rear display unit 3. The front display unit 2 is parallel to the rear display unit 3. The front display unit 2 has a transparent panel which transmits the light from the image of the rear display unit 3. The front display unit 2 is therefore referred to as the transparent display panel. The front display unit 2 and rear display unit 3 show the identical images having different brightness. The different brightness is given to the respective images, depending upon the distances from a viewer. The light from the image of the front display unit 2 proceeds forward (to the left in the drawing), and the light from the image of the rear display unit 3 also proceeds forward through the front display unit 2.

The viewer does not perceive two separate (independent) images when the viewer sees the image of the front display unit 2 and the image of the rear display unit 3. Rather, the viewer perceives only one image because the two images fuse with each other. When the viewer sees the fused image, the viewer perceives a three-dimensional image having a certain thickness in the right-and-left direction in FIG. 1, depending upon the different brightness of the original two images.

The image displaying apparatus 1 can present a three-dimensional image which the viewer feels natural. Since the fused image is not a contrived (factitious) image, the viewer's eyes do not become fatigued very much.

If a shock is applied to the image displaying apparatus 1, the relative positional relationship between the front and rear display units 2 and 3 changes. As the relative positional relationship change occurs, the positions of the two images of the two display units 2 and 3 for the viewer change. Thus, the two images do not fuse properly, and the viewer no longer perceives a satisfactory three-dimensional image.

### SUMMARY OF THE INVENTION

According to one aspect of the present invention, there is provided an improved three-dimensional image displaying apparatus including a front display unit and a rear display unit. The front display unit has at least one transparent display screen. The transparent display screen includes a plurality of organic electroluminescent elements. The rear display unit is located behind the front display unit. A spacer is connected (inserted) between the front display unit and the rear display unit. The distance between the front and rear display units is primarily determined by the width of the spacer. Thus, the distance between the front and rear display units can be adjusted by employing the spacer having a desired width.

According to another aspect of the present invention, there is provided a method of making a three-dimensional image displaying apparatus. The method includes providing a front display unit, providing a rear display unit, and connecting the front display unit with the rear display unit by a spacer such that a display screen of the front display unit is parallel to a display screen of the rear display unit. The front display unit is firmly connected to the rear display unit by the spacer. Therefore, the image displaying apparatus can stably present a three-dimensional image of a good quality.

Other objects, aspects and advantages of the present invention will become apparent to those skilled in the art to which the present invention pertains from the subsequent detailed description of the invention and the appended claims, taken in conjunction with the accompanying drawings.

### BRIEF DESCRIPTION OF THE DRAWINGS

FIG. 1 illustrates a cross sectional view of a conventional apparatus for displaying a three-dimensional. image;

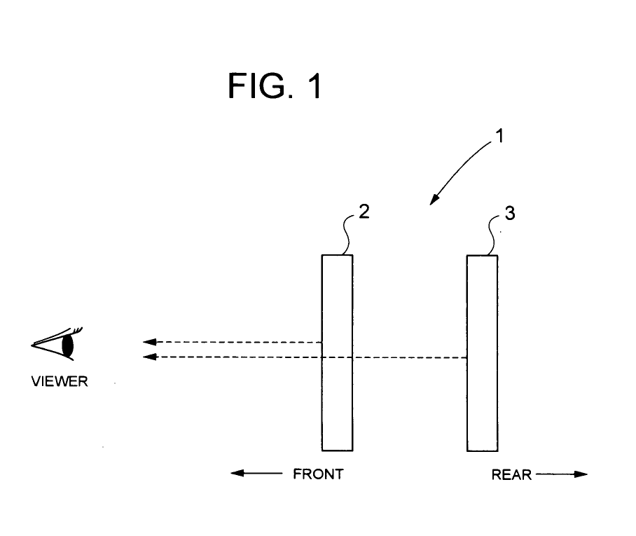

FIG. 2 illustrates a cross sectional view of an apparatus for displaying a three-dimensional image according to one embodiment of the present invention;

FIG. 3 illustrates a cross sectional view of an image displaying apparatus according to a modified embodiment; and

FIG. 4 illustrates a cross sectional view of an image displaying apparatus according to another modified embodiment.

### DETAILED DESCRIPTION OF THE INVENTION

An embodiment of a three-dimensional image displaying apparatus according to the present invention will be described with reference to the accompanying drawings. It should be noted that for the sake of description, external driving circuits, internal electrodes and other structures and parts for the image displaying apparatus are omitted in the following description and the accompanying drawings.

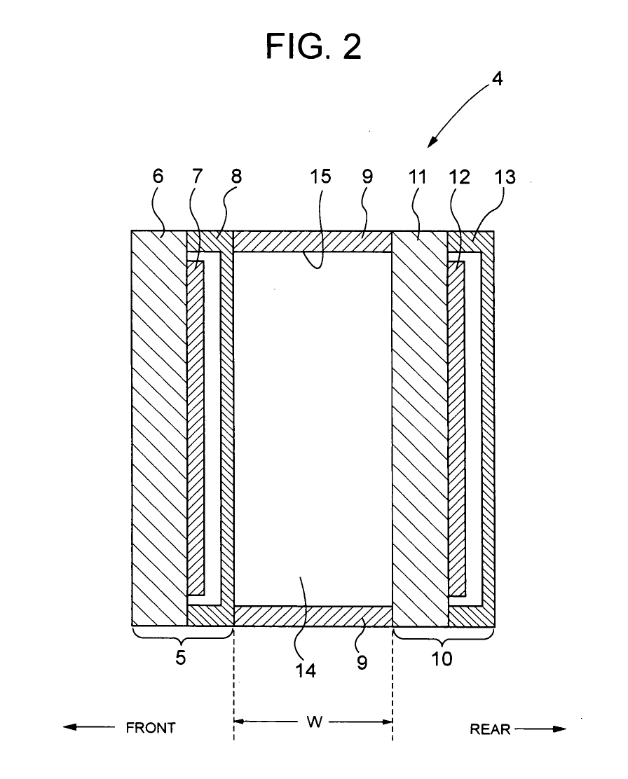

Referring to FIG. 2, a three-dimensional image displaying apparatus 4 includes a front display unit 5. The front display unit 5 is a transparent display panel. In this embodiment, the front display unit 5 has an organic electroluminescent (referred to as“EL” hereinafter) display screen. The organic EL display screen is a passive-matrix type, for example. A plurality of organic EL elements are arranged in the display screen.

The front display unit 5 has a substrate 6 made from a transparent material. An organic functional layer 7 is provided on the substrate 6. The organic functional layer 7 has a light emitting layer, which is electroluminescent. The organic functional layer 7 contains a micromolecular organic compound and a macromolecular organic compound. It should be noted that the organic functional layer 7 may be a combination of a plurality of functional layers such as an electron injection layer, an electron transport layer, a positive hole transport layer and a positive hole injection layer.

The organic functional layer 7 is enclosed by a sealing can (airtight casing) 8 made from a transparent material. The can 8 prohibits penetration/intrusion of water (moisture) and gas (e.g., oxygen) from the exterior of the can 8. In order to prevent the organic functional layer 7 from being deteriorated by the moisture and prevent creation of areas that do not emit light (so-called “dark spots”), the can 8 has a sealing effect.

A cylindrical spacer 9 is located behind the front display unit 5. The spacer 9 firmly supports the front display unit 5 by means of a fixing agent or device such as an adhesive. The spacer 9 is made from a resin, metal, glass or any other suitable material.

A rear display unit 10 is located behind the spacer 9. The rear display unit 10 is parallel to the front display unit 5. The rear display unit 10 is an organic EL display panel. The rear display unit 10 is secured to the spacer 9 by a suitable fixing agent or device. Like the front display unit 5, the rear display unit 10 has a substrate 11, an organic functional layer 12 and a sealing can 13.

The light from the image displayed in the front display unit 5 proceeds forward (to the right in FIG. 2), and the light from the image displayed in the rear display unit 10 proceeds forward through the front display unit 5. A viewer perceives a fused light, created from the light emitted from the image of the front display unit 5 and the light emitted from the image of the rear display unit 10.

Because the front and rear display units 5 and 10 are fixed to the spacer 9 located between the front and rear display units 5 and 10, the relative positional relationship between the front and rear display units 5 and 10 does not change even if a shock is applied to the image displaying apparatus 4. As a result, the image displaying apparatus 4 can present a stable three-dimensional image.

The spacer 9 can have an arbitrary width W. The distance between the front and rear display units 5 and 10 is determined by the width W of the spacer 9. Thus, it is possible to change the distance between the front and rear display units 5 and 10.

It should be noted that the shape of the spacer 9 is not limited to a cylindrical shape. Any suitable shape may be chosen as long as the spacer 9 can firmly support the front and rear display units 5 and 10 and maintain the distance between the two display units. For example, the spacer 9 may be made from a plurality of poles or elongated members. The spacer 9 is not required to have a cavity (hollow space) 14 therein. The spacer 9 may be a transparent plate member that spans the front display unit 5 and the rear display unit 10. The spacer 9 may have a width adjustment mechanism, such as an elongatable/shrinkable (collapseable) device, so that the spacer 9 can change the width W even after the image displaying apparatus 4 is assembled. By adjusting the distance between the front and rear display units 5 and 10, the display condition of the three-dimensional image can be adjusted.

Preferably, the spacer 9 has a reflection suppressing characteristic. For instance, the spacer 9 has an anti-reflection film attached to its inner wall 15. If the spacer 9 has the anti-reflection (light absorbing) characteristic, scattered light created between the front and rear display units 5 and 10 is not reflected by the spacer 9. Therefore, the scattered light is not transmitted to the front. Accordingly, the image displaying apparatus 4 can present a clearer three-dimensional image.

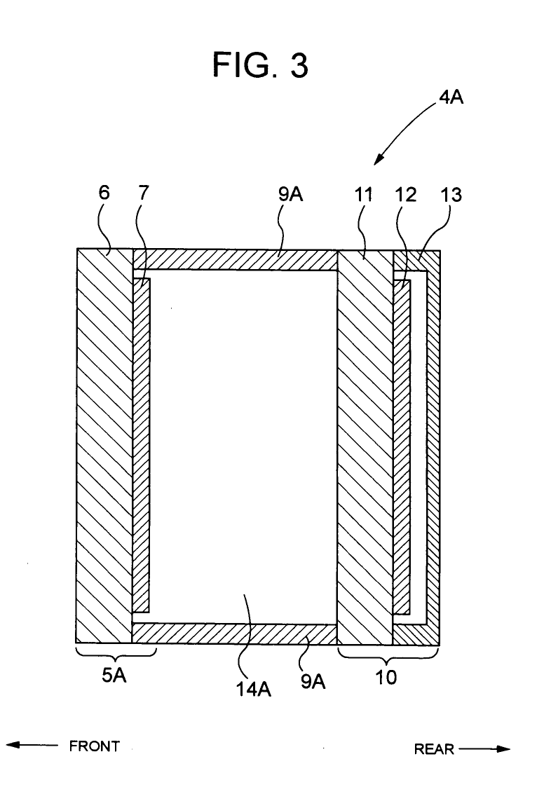

The spacer 9 may be made from a material that does not transmit a gas. If the spacer 9 does not allow gas penetration, the spacer 9 and the rear display unit substrate 11 can create a sealing structure. Then, the sealing can 8 for the front display unit 5 becomes unnecessary. This will be described with reference to FIG. 3.

In FIG. 3, the front display unit 5A does not have a sealing can because the sealing structure provided by the spacer 9A and the rear display unit substrate 11 can serve as the sealing can for the organic functional layer 7. The spacer 9A, the front display unit substrate 6 and the rear display unit substrate 11 are coupled hermetically or air-tightly with each other by an adhesive or the like. Preferably, the cavity 14A between the front display unit 5A and the rear display unit 10 is filled with an inert gas, such as nitrogen, and is kept dry. The distance between the front and rear display units 5A and 10 can be reduced, as compared with the apparatus 4 shown in FIG. 2, because the sealing can for the front display unit is eliminated.

If the sealing can is not provided, no light reflection occurs due to the sealing can. The light reflected by the sealing can would blur (degrade the clarity of) the image. Therefore, the image displaying apparatus 4A of FIG. 3 is able to present a three-dimensional image having clear contours.

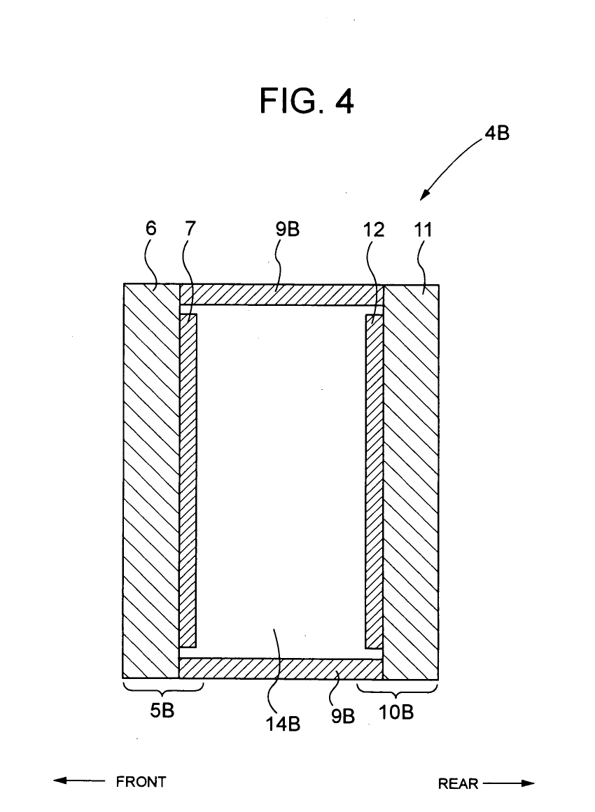

Referring to FIG. 4, another image displaying apparatus 4B is illustrated. In this modification, the organic functional layer 12 of the rear display unit 10B is situated in the space 14B between the front and rear display units 5B and 10B. The organic functional layers 7 and 12 are enclosed by the spacer 9B, the front display unit 5B and the rear display unit 10B. Therefore, the image displaying apparatus 4B does not have a sealing can. The image displaying apparatus 4 shown in FIG. 2 has two sealing cans 8 and 13, and the image displaying apparatus 4A shown in FIG. 3 has a single sealing can 13.

A process of making the image displaying apparatus 4 (4A, 4B) will be described. The process includes providing the front display unit and providing the rear display unit. The step of providing the front display unit includes making the organic EL display screen. The step of making the organic EL display screen includes forming the organic functional layer(s) on a substrate. This step may also include providing or forming the sealing can(s) to enclose the organic functional layer(s).

After providing the front and rear display units, the front display unit is positioned in parallel to the rear display unit. The display screen of the front display unit should be parallel to the display screen of the rear display unit.

Then, the spacer is placed between the front and rear display units. The step of providing the spacer includes fixing the spacer to the front and rear display units by a fixing agent (e.g., an adhesive) or device.

The image displaying apparatus is fabricated by the above described steps.

Since the front and rear display units are firmly united by the spacer, the image displaying apparatus can stably present a three-dimensional image of good quality.

After one or both of the two organic functional layers 7 and 12 are formed, one or both of the organic functional layers may be placed and hermetically enclosed in the space 14A (14B) between the front and rear display units, if the image displaying apparatus 4A or 4B should be fabricated. The step of enclosing the organic functional layer(s) creates a structure that prevents invasion/penetration of moisture and gas (e.g., oxygen). If the organic functional layer 7 (12) is located in the sealed structure, the organic functional layer does not need a sealing can for itself. This simplifies the image displaying apparatus manufacturing process because a certain manufacturing step is unnecessary. In addition, if the sealing can 8 (13) is dispensed with, the thickness of the image displaying apparatus 4 (4A, 4B) can be reduced.

The sealing can may be made from a metal or any other suitable material.

The sealing can 8 (13) may be replaced by a sealing film made from a resin or other lightweight material. Such sealing film can be made lightweight and thin so that the display panel inducing the sealing film, instead of the sealing can, can be thin. Alternatively, the sealing can 8 (13) may be replaced by a sealing coating or member made from an inorganic compound (e.g., SiN). Such sealing coating or member can be made lightweight and thin so that the display panel including the sealing coating or member, instead of the sealing can, can be thin.

It should be noted that the display panel is not limited to the organic EL display panel. For example, the display panel of the front (rear) display unit may be a liquid crystal display panel.

It should also be noted that the front display unit 5 (5A, 5B) may include two or more display screens.

This application is based on a Japanese patent application No. 2003-15933, and the entire disclosure thereof is incorporated herein by reference.

What is claimed is:

1. A three-dimensional image displaying apparatus comprising:
a front display unit having at least one transparent display screen, the at least one transparent display screen including a plurality of organic electroluminescent elements;
a rear display unit located behind the front display unit and having a display screen; and
a spacer connected between the front display unit and the rear display unit.

2. The three-dimensional image displaying apparatus according to claim 1, wherein the spacer prevents transmission of gas.

3. The three-dimensional image displaying apparatus according to claim 1, wherein the spacer is a cylindrical member.

4. The three-dimensional image displaying apparatus according to claim 1, wherein the spacer is a transparent plate member.

5. The three-dimensional image displaying apparatus according to claim 1, wherein the spacer has an anti-reflection characteristic.

6. The three-dimensional image displaying apparatus according to claim 1, wherein the spacer includes a mechanism for adjusting a width of the spacer to adjust a distance between the front display unit and the rear display unit.

7. The three-dimensional image displaying apparatus according to claim 1, wherein the front display unit includes a first organic functional layer and the rear display unit includes a second organic functional layer.

8. The three-dimensional image displaying apparatus according to claim 1, wherein the spacer is hermetically connected between the front display unit and the rear display unit.

9. The three-dimensional image displaying apparatus according to claim 7, wherein the spacer has a hollow space and at least one of the first and second organic functional layers is located in the hollow space of the spacer.

10. The three-dimensional image displaying apparatus according to claim 9, wherein at least one of the first and second organic layers is covered with a sealing device.

11. The three-dimensional image displaying apparatus according to claim 1, wherein the spacer is a solid member.

12. The three-dimensional image displaying apparatus according to claim 1, wherein the spacer includes a plurality of poles.

13. The three-dimensional image displaying apparatus according to claim 1, wherein the spacer has a coating that restrains reflection.

14. The three-dimensional image displaying apparatus according to claim 1, wherein the spacer is a hollow member filled with an inert gas.

15. A method of making a three-dimensional image displaying apparatus, comprising:
providing a front display unit;
providing a rear display unit; and
connecting the front display unit with the rear display unit by a spacer such that a display screen of the front display unit is parallel to a display screen of the rear display unit.

16. The method according to claim 15, wherein the step of providing the front display unit includes providing an organic electroluminescent display screen made from a plurality of organic electroluminescent elements.

17. The method according to claim 16, wherein the front display unit has at least one transparent display screen, and the rear display unit is located behind the front display unit.

18. The method according to claim 17, wherein the organic electroluminescent display screen includes an organic functional layer which has a light emitting layer, and the light emitting layer emits light upon application of a current.

19. The method according to claim 18, wherein the front display unit is hermetically connected with the rear display unit by the spacer.

20. The method according to claim 19 further including locating the organic functional layer in a hermetic confinement defined by the front display unit, spacer and rear display unit.
